(19) United States
(12) Patent Application Publication
(10) Pub. No.: US 2010/0068359 A1
(43) Pub. Date: Mar. 18, 2010

(54) PRESERVATIVE METHOD

(75) Inventors: Bernard Charles SEKULA, Glen Gardner, NJ (US); Michael Charles CIRIGLIANO, Cresskill, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/210,277

(22) Filed: Sep. 15, 2008

(51) Int. Cl. A23L 3/3454

(52) U.S. Cl. 426/321

(57) ABSTRACT

A method for preserving a food dressing composition is described. The method includes replacement of sodium chloride with potassium chloride or ammonium chloride in order to produce a food dressing composition free of spoilage and pathogens.

### FIELD OF THE INVENTION

The present invention is directed to a preservative method. More particularly, the present invention is directed to a method for preserving a food dressing composition comprising (a) providing a sodium reduced dressing composition which would become microbiologically unstable within about 4 weeks to about 6 weeks at ambient temperature due to said sodium reduction; and (b) adding KCl and/or NH₄Cl to said sodium reduced dressing composition, in order to produce a food composition free of spoilage and pathogens, i.e., that is microbiologically safe and stable.

### BACKGROUND OF THE INVENTION

Dressing compositions, such as salad dressings, mayonnaise and mayonnaise-type sauces, usually contain salt (sodium chloride or NaCl) in addition to other conventional ingredients such as acetic acid or citric acid, and are usually formulated to be microbiologically stable and safe. However, when salt is removed, such as for health or other reasons, from an otherwise stable system, outgrowth of undesirable yeast and bacteria can occur within about 4 to about 6 weeks. Examples of spoilage microorganisms capable of growth in a compromised dressing system include acid and preservative resistant (APRY) yeast, such as Zygosaccharomyces bailii and/or Zygosaccharomyces rouxii, and lactic acid bacteria (LABs), such as Lactobacillus fructovorans and Lactobacillus plantarum.

It is of increasing interest to develop a natural preservative system that may be used to preserve dressing compositions with reduced sodium as described above, including ambient stable and chilled dressing compositions. It is also of interest to develop a preservative system that may be used to preserve mayonnaise. This invention, therefore, is directed to a method for preserving a dressing composition with a preservative system comprising adding potassium chloride or ammonium chloride to the reduced sodium dressing composition, particularly mayonnaise. The method of this invention, unexpectedly, results in a microbiologically stable and safe dressing composition with reduced sodium.

### Additional Information

Use of available nitrogen supplements, such as ammonia and/or di-ammonium hydrogen phosphate (DAP), has been disclosed as a yeast nutrient in Henick-Kling, T., et al., “Yeast Nutrients,” Food Science 430.

Efforts have been disclosed for making low sodium salt seasonings with a focus on sensory taste attributes. Zasypkin, et al., Published Patent Application No. US2007/0292592 describes a salt replacing food composition.

Efforts have been disclosed for studying preservative systems. The Bidlas and Lambert publication entitled “Comparing the antimicrobial effectiveness of NaCl and KCl with a view to salt/sodium replacement,” International Journal of Food Microbiology 124 (2008) 98-102 describes a study of salt replacement effects on certain pathogens.

None of the additional information above describes a method for using a chloride salt of potassium or ammonium to render otherwise unstable sodium reduced dressings compositions microbiologically stable and safe.

### SUMMARY OF THE INVENTION

The present invention is directed to a method for preserving a food dressing composition comprising:
(a) providing a sodium salt reduced dressing composition which would become microbiologically unstable within about 4 weeks to about 6 weeks at ambient temperature due to said sodium reduction; and
(b) adding KCl and/or NH₄Cl to said sodium reduced dressing composition
   thereby rendering said food composition microbiologically safe and stable. In other words, the NaCl may be replaced with KCl or NH₄Cl or both in a dressing system. Preferably, the dressing composition is a mayonnaise comprising acetic acid or citric acid, and is substantially free of other preservative acids.

In particular, the term microbiologically safe and stable (i.e., spoilage free) as used herein with respect to a dressing compositions means the food composition displays no outgrowth of spoilage bacteria (e.g. Lactobacilli), yeast and mold for at least about six (6) months before opening and when kept at a temperature of about 25° C. and at a pH of less than about 4.2, or for at least about six (6) weeks before opening when kept at a pH of less than about 6 at a temperature of about 5° C. (chilled), and prevents the outgrowth of pathogens, and (for products kept at about 25° C. and 5° C.) achieves at least a 2 log decline of pathogens (like Listeria monocytogenes) within about a fourteen (14) day period when kept at a pH about 3.0 to less than about 5.0.

Within about, as used herein, means the event may happen sooner than the stated period of time.

Acid and Preservative Resistant Yeast (“APRY yeast”), as used herein, means yeast the growth and/or life of which are more resistant to the effects of acids and/or preservatives, especially acids and/or preservatives commonly used in dressings such as acetic, lactic or citric acid, and that which can better tolerate and compete at lower water activities (A_{w}), particularly Zygosaccharomyces bailii and/or Zygosaccharomyces rouxii. Note, calcium chloride and magnesium chloride have been found to enhance Z. bailii outgrowth.

Dressing composition, as used herein, means a food composition suitable for consumption by humans with another food, such as a mayonnaise or mayonnaise type dressing or sauce, and salad dressing. Often, such dressings are acidified to a pH of less than about 4.5, preferably to a pH of less than about 4.0, and more preferably to a pH of about 3.6 to about 3.8, and may comprise acetic acid, citric acid, lactic acid, and other food grade acids. Dressing composition as used herein is independent of oil level. Preferred dressing compositions are oil-in-water emulsions. Most preferred dressing compositions are full fat mayonnaise compositions containing 65% or more oil.

Sodium reduced dressing composition, as used herein, means a dressing composition which has sufficiently less sodium salt than an original microbiologically safe and stable dressing composition so as to result in a composition that is not microbiologically safe and stable due to such sodium reduction. Sodium reduction includes but is not limited to reduction of sodium chloride by about 10 to about 100 mole percent, preferably about 12.5 to about 50 mole percent, and including specifically 37.5 mole percent within the preferred range, and including all ranges subsumed therein.

Notably, the salt replacement for purposes of preservation according to the present invention is done on a mole-for-mole basis.

### DETAILED DESCRIPTION OF THE INVENTION

The present invention is directed to a method for preserving a dressing composition comprising:
(a) providing a sodium salt reduced dressing composition which would become microbiologically unstable within about 4 weeks to about 6 weeks at ambient temperature due to said sodium reduction; and
(b) adding KCl and/or NH4Cl to said sodium reduced dressing composition
   thereby rendering said food composition microbiologically safe and stable.

The present invention is directed to preserving dressing compositions regardless of oil level, although oil levels usually range from about 0.5 to about 80 wt. %. Often, such dressings are acidified to a pH of less than about 4.5 and may comprise acetic acid, citric acid, lactic acid, and other food grade acids. Dressing compositions include a mayonnaise or mayonnaise type dressings or sauces, and salad dressing. Preferred dressing compositions are oil-in-water emulsions.

The preferred mayonnaise compositions according to the present invention are food compositions that contain acetic acid and/or citric acid as acidifier, mustard, salt, and vegetable oil. For mayonnaise and mayonnaise type sauces, the oil content preferably ranges from about 3 to about 80 wt. %. Full-fat mayonnaise has an oil content of about 65 to about 80 wt. %. Reduced oil mayonnaise products preferably have an oil content of less than 65 wt. %. Light mayonnaise preferably has an oil content of less than about 35 wt. % to preferably about 20 wt. %. Low-fat mayonnaise preferably as an oil content of about 3 to about 5 wt. %.

The present invention addresses the discovery that reducing the amount of salt (sodium chloride) found in conventional dressing compositions renders them microbiologically unsafe and unstable. Sodium reduction includes but is not limited to reduction of sodium chloride by about 10 to about 100 mole percent, preferably about 12.5 to about 50 mole percent, and including specifically 37.5 mole percent within the preferred range, and including all ranges subsumed therein. In particular, sodium reduction destabilizes dressing systems, allowing microorganisms to survive and/or thrive in once inhospitable environments.

While motivated by sodium reduction, Applicants have found that full to partial replacement of sodium chloride with potassium chloride (KCl) and/or ammonium chloride (NH₄Cl) returns the compositions to a state of microbiological safety and stability.

Potassium chloride and ammonium chloride can be obtained in purified food grade form, including anhydrous crystalline, solution, dispersion or concentrated slurry. Ammonium chloride is available, for example, from Fisher Scientific, Fair Lawn, N.J., as a colorless or white crystalline powder. The molecular weight of NH₄Cl is 53.49. Mole for mole replacement of sodium chloride with potassium chloride and/or ammonium chloride may take place at from about 10 to about 100 mole percent reduction and replacement preferably about 12.5 to about 50 mole percent, and including specifically 37.5 mole percent within the preferred range, and including all ranges subsumed therein. The water activity (Aw) plays no role in the inventive method, particularly because the APRY yeast that is being targeted in not affected by the A_{w} of typical dressing compositions.

### Optional Preservatives

As to the optional preservative components, the same are used in the food dressing compositions in amounts of about 0.0% to about 0.500%, preferably about 0.015% to about 0.300%, more preferably about 0.100% to about 0.200 % by weight of the food composition.

Illustrative and non-limiting examples of optional preservatives suitable for use in this invention include sorbic acid, benzoic acid, cinnamic acid, propanoic, 2-hydroxypropanoic (lactic), butyric, propionic, phosphoric, adipic, gluconic, malic, tartaric, ascorbic, carnosic acid, salts thereof, derivatives thereof, mixtures thereof as well as mustard extract, nisin, natamycin, and lauric arginate ester.

Typically, the food dressing compositions made via the method of this invention have from about 0.001 to about 1.5 percent by weight, and preferably, from about 0.005 to about 0.4 percent, and most preferably, from about 0.01 to about 0.30 percent by weight optional preservative, based on total weight of food composition and including all ranges subsumed therein.

### Method

Applicants have discovered an optimized method of preparing sodium reduced dressing compositions in order to maintain microbiological stability and safety as defined herein. Note, reduced sodium food dressing formulations according to the present invention are those that would become microbiologically unstable and/or unsafe as a result of reducing only the sodium content as compared to the original formulation. In the process according to the present invention, KCl and NH₄Cl are used to replace NaCl on a mole-for-mole basis. In other words, when NaCl is reduced by about 12 mole % to about 50 mole %, about 12 mole percent to about 50 mole percent of KCl and/or NH₄Cl is added back.

Surprisingly, when conducting the method of this invention, a dressing composition, like a mayonnaise, mayonnaise type sauce, or salad dressing, is rendered microbiologically safe and stable without the need for additional preservatives.

Illustrative and non-limiting examples of preferred food compositions prepared via the method of this invention include pourable dressings and mayonnaise type dressings with reduced salt (NaCl) levels of about 10 to about 90 mole percent. The relatively low salt content of such dressings requires use of KCl and/or NH₄Cl in the formulation.

Preferred food compositions can also comprise starches, cellulose, citrus fiber, gums, vitamins, chelators, buffers, antioxidants, colorants, acidulants (including inorganic acids), emulsifiers, sweeteners, syrups, alcohol, water, milk, food grade dispersants or stabilizers (like propylene glycol alginate), solubilizing agents (like propylene glycol), dairy powders or mixtures thereof.

The packaging suitable for use with the food compositions made according to this invention is often a glass jar, food grade sachet, a plastic tub or squeezable plastic bottle. Sachets are preferred for food service applications, a tub is preferred for spreads or dips, and a squeezable plastic bottle is often preferred for mayonnaise and mayonnaise type sauces.

The following examples are provided to illustrate an understanding of the present invention. The examples are not intended to limit the scope of the claims.

### EXAMPLE 1

This example demonstrates the effects of reducing or replacing salt on the behavior of spoilage microorganisms in mayonnaise. The results show that APRY yeast outgrowth is triggered as sodium chloride (NaCl) is removed or reduced, and that the APRY yeast inhibition can be restored with concomitant addition of KCl or NH₄Cl.

### Procedure

1. A Full Fat (75% oil) Mayonnaise Model composition was used to assess the impact of replacement of sodium chloride (table salt) with ammonium chloride or potassium chloride on the behavior of spoilage microorganisms (i.e. LABs & APRY). The formulations tested are shown in the Tables 1 and 2 below.
2. Formula adjustments were made to keep aqueous acetic acid and sugar levels constant, i.e. % active/(% water+% active)×100,

i.e., about 1.53% to about 1.54% aqueous acetic acid and about 6.32% to about 6.36% aqueous sugar.
3. Replacement of sodium chloride with ammonium chloride or potassium chloride was done on an equal molal basis, i.e., on a moles per kilogram product basis.
4. All batches (control, 50%, 37.5%, 25% & 12.5% sodium chloride reduction and/or replacement on equal molal basis) were prepared in the laboratory using batch set-up and a conventional process for making mayonnaise.
5. Analytical data supported that the per cent replacement targets were met,

e.g. 100% sodium chloride replacement (equal molal basis) sample was checked analytically and the potassium chloride level was found to 11035 ppm.
6. Samples were challenged at two inoculum levels (week −1 represented the number of viable organisms just prior to their introduction into the products being tested), e.g. 10¹-10² and 10³-10⁴ cfu/g.
7. The results of the challenge study over a number of weeks were reported (see Challenge Data in the Tables 3, 4 and 5 below).

### Key Findings

### I. Control

Challenge data for the control microbiologically safe and stable mayonnaise system is shown in Table 3 (A and B). No outgrowth at high & low insult levels is observed over a period of about 10 to about 12 weeks

### II. Sodium Chloride Reduction (Without Replacement)

1. Reducing aqueous sodium from 8.23% to 7.21% (about a 12.5% reduction) and to 6.18% (25% reduction) allowed for APRY outgrowth at the high insult level (compare #618 control in Table 3 with #619 and 620 in Table 4)
2. Reducing aqueous sodium from 8.23% to 5.16% (37.5% reduction) allowed for APRY outgrowth at low and high insult levels (see #621 in Table 4)
3. Sodium reductions up to 50% in this model had no effect on the microbiological behavior of lactic acid bacteria (see #619 through 622 in Table 4)
   III. Sodium Chloride Replacement with Ammonium Chloride
1. 12.5% to 50% replacement of sodium (chloride) with ammonium (chloride) on a mole-for-mole basis resulted in no change in the microbiological behavior as compared to control (see #728 through 731 in Table 5)
2. Die-off patterns were essentially identical regardless of the salt(s) present except for APRY high insult level.
3. Increasing the replacement of salt on a mole-for-mole basis with ammonium chloride resulted in faster APRY die-off (see #728 through #731 in Table 5)
   IV. Sodium Chloride Replacement with Potassium Chloride
1. 12.5% to 100% replacement of sodium with potassium on a mole-for-mole basis resulted in no change in the microbiological behavior (see #623 through 627 in Table 6)
2. Replacement of 93.75% sodium with 87.5% potassium (i.e. 6.25% cation reduction) on a molal basis resulted in no change in the microbiological behavior (see #628)
3. Replacement of 87.5% sodium with 75% potassium (i.e. 12.5% cation reduction) on a molal basis allowed for APRY outgrowth at the high insult level. The response was similar to that seen with a straight 12.5% sodium reduction (see #619)
4. Replacement of sodium with potassium had no effect on the microbiological behavior of lactic acid bacteria (see #623 through 629)

### Key Learnings

I. Control is microbiologically stable.
II. Sodium chloride reduction, without replacement (or without sufficient replacement), in an otherwise microbiogically safe and stable mayonnaise composition allowed for APRY outgrowth.
III. Ammonium functions similarly to sodium with regards to microbiological behavior of APRY & LAB in full fat mayonnaise model.
IV. Potassium functions similarly to sodium with regards to microbiological behavior of APRY & LAB in full fat mayonnaise model.

Table 1 shows partial salt replacement with NH4Cl. Test point 1 is the control used throughout this Example, a microbiologically stable full sodium chloride containing mayonnaise composition.

TABLE 1
Formulations Tested With NH₄Cl - Partial Salt Replacement

| | | 50% Na | 37.5% Na | 25% Na | 12.5% Na |
|---|---|---|---|---|---|
| | Control | replacement | replacement | replacement | replacement |
| | TEST POINTS | | | | |
| | 1 (#727) | 6 (#728) | 7 (#729) | 8 (#730) | 9 (#731) |
| | % Formula | % Formula | % Formula | % Formula | % Formula |
| Soybean Oil | 75.004 | 75.004 | 75.004 | 75.004 | 75.004 |
| Vinegar, 120 grain | 2.500 | 2.508 | 2.506 | 2.504 | 2.502 |
| Citric Acid | 0.015 | 0.015 | 0.015 | 0.015 | 0.015 |
| Water | 12.229 | 12.290 | 12.274 | 12.259 | 12.244 |
| Egg blend, salted | 7.655 | 7.655 | 7.655 | 7.655 | 7.655 |
| NaCl, added | 0.945 | 0.075 | 0.292 | 0.510 | 0.728 |
| NH₄Cl, added | | 0.797 | 0.598 | 0.399 | 0.199 |
| Flavors | 1.645 | 1.650 | 1.649 | 1.647 | 1.646 |
| EDTA | 0.008 | 0.008 | 0.008 | 0.008 | 0.008 |
| Total | 100.000 | 100.000 | 100.000 | 100.000 | 100.000 |
| pH | 3.77 | 3.83 | 3.81 | 3.81 | 3.81 |

TABLE 2
Formulations Tested With KCl

| Test | Challenge | % Na | % K | |
|---|---|---|---|---|
| Points | Study No. | Reduction | Replacement | pH |
| | Control | | | 3.81 |
| 1 | #618 | 0 | 0 | |
| 2 | #619 | 12.5 | 0 | |
| 3 | #620 | 25 | 0 | |
| 4 | #621 | 37.5 | 0 | |
| 5 | #622 | 50 | 0 | |
| 6 | #623 | 100 | 100 | 4.04 |
| 7 | #624 | 12.5 | 12.5 | |
| 8 | #625 | 25 | 25 | |
| 9 | #626 | 37.5 | 37.5 | |
| 10 | #627 | 50 | 50 | |
| 11 | #628 | 93.75 | 87.5 | |
| 12 | #629 | 87.5 | 75 | |

The control Formulation 1 in Table 2 is the same as in Table 1. In addition to the control, Table 2 shows eleven more compositions with varied sodium chloride and potassium chloride contents as indicated therein. In Test Points 2 through 5, sodium chloride is reduced without being replaced. The results of the stability/spoilage challenge studies for these compositions are shown in the Tables below, starting with Table 3 which shows the Control.

The results show that food compositions are unexpectedly microbiologically stable and safe when subjected to the method of this invention.

TABLE 3A
Challenge Data - Control: 8.23% aqueous Na

| | | | | Yeast | 2.24E+07 | per ml | Assumed 1,000,000/ml | | | |
|---|---|---|---|---|---|---|---|---|---|---|
| | | | | Pool | | | | | | |
| | | | | Lactic | 7.28E+09 | per ml | Assumed 1,000,000,000/ml | | | |
| | | | | Pool | | | | | | |
| #727 | | Calculated | | | | | | | | |
| Test # 1 | | Inoculum | | | | | | | | |
| 0% Na Reduction and | Weeks | −1 | 0.0 | 1.0 | 2.0 | 4.0 | 6.0 | 8.0 | 10.0 | 12.0 |
| Replacement | Lactics Hi | 7,280 | 8,800 | 9 | 9 | 9 | 9 | 9 | 9 | 9 |
| | Lactics Lo | 72 | 90 | 9 | 9 | 9 | 9 | 9 | 9 | 9 |
| Aw .929 | Uninoc. (PDA) | | 9 | 9 | 9 | 9 | 9 | 9 | 9 | 9 |
| | Uninoc. (MRS) | | 30 | 9 | 9 | 9 | 9 | 9 | 9 | 9 |
| | APRY Hi | 22,400 | 12,200 | 4,100 | 2,400 | 840 | 220 | 30 | 9 | 10 |
| | APRY Lo | 224 | 130 | 20 | 10 | 9 | 9 | 9 | 9 | 9 |

TABLE 3B
Challenge Data - Control: 8.23% aqueous Na

| | | | | Yeast | 2.32E+07 | per ml | Assumed 1,000,000/ml | | | |
|---|---|---|---|---|---|---|---|---|---|---|
| | | | | Pool | | | | | | |
| | | | | Lactic | 2.30E+09 | per ml | Assumed 1,000,000,000/ml | | | |
| | | | | Pool | | | | | | |
| #618 | | Calculated | | | | | | | | |
| 0% Na Reduction and | | Inoculum | | | | | | | | |
| Replacement | | | | | | | | | | |
| Point #1 Control | Weeks | −1 | 0.0 | 1.0 | 2.0 | 4.0 | 6.0 | 8.0 | 10.0 | 12.0 |
| pH 3.89 | Lactics Hi | 2,300 | 7,800 | 9 | 9 | 9 | 9 | 9 | 9 | |
| | Lactics Lo | 23 | 60 | 9 | 9 | 9 | 9 | 9 | 9 | |
| | APRY Hi | 23,200 | 9,400 | 1,680 | 280 | 20 | 9 | 9 | 9 | |
| | APRY Lo | 232 | 140 | 20 | 9 | 9 | 9 | 9 | 9 | |
| | Uninoc. (PDA) | | 9 | 9 | 9 | 9 | 9 | 9 | 9 | |
| | Uninoc. (MRS) | | 9 | 9 | 9 | 9 | 9 | 9 | 9 | |

TABLE 4
Challenge Data - Sodium Chloride Reduction (without replacement)

| | | | | | | | | | | |
|---|---|---|---|---|---|---|---|---|---|---|
| #619 | | Calculated | | | | | | | | |
| Na Reduced Mayo | | Inoculum | | | | | | | | |
| (7.21% aqueous | | | | | | | | | | |
| sodium) | | | | | | | | | | |
| Point #2 | Weeks | −1 | 0.0 | 1.0 | 2.0 | 4.0 | 6.0 | 8.0 | 10.0 | 12.0 |
| (12.5% reduction) | | | | | | | | | | |
| pH 3.86 | Lactics Hi | 2,300 | 500 | 10 | 9 | 9 | 9 | 9 | 9 | |
| Observation: | Lactics Lo | 23 | 30 | 9 | 9 | 9 | 9 | 9 | 9 | |
| APRY Hi was unstable | APRY Hi | 23,200 | 7,800 | 1,960 | 1,080 | 26,000 | 212,800 | 137,000 | 290,000 | |
| After 4 weeks | APRY Lo | 232 | 150 | 20 | 9 | 9 | 9 | 9 | 9 | |
| | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| #620 | | | | | | | | | | |
| Na Reduced Mayo | Lactics Hi | 2,300 | 4,400 | 9 | 9 | 9 | 9 | 9 | 9 | |
| Point #3 | Lactics Lo | 23 | 50 | 9 | 9 | 9 | 9 | 9 | 9 | |
| (25% reduction) | | | | | | | | | | |
| pH 3.77 | APRY Hi | 23,200 | 11,200 | 7,700 | 56,400 | 96,000 | 98,000 | 144,000 | 296,000 | |
| Observation: | APRY Lo | 232 | 250 | 20 | 9 | 9 | 9 | 9 | 9 | |
| APRY Hi was unstable | Uninoc. (PDA) | | 9 | 9 | 9 | 9 | 9 | 9 | 9 | |
| After 2 weeks | Uninoc. (MRS) | | 9 | 9 | 9 | 9 | 9 | 9 | 9 | |
| #621 | | Calculated | | | | | | | | |
| Na Reduced Mayo | | Inoculum | | | | | | | | |
| by 37.5% | | | | | | | | | | |
| Point #4 | Weeks | −1 | 0.0 | 1.0 | 2.0 | 4.0 | 6.0 | 8.0 | 10.0 | 12.0 |
| pH 3.8 | Lactics Hi | 2,300 | 6,200 | 9 | 9 | 9 | 9 | 9 | 9 | |
| | Lactics Lo | 23 | 40 | 9 | 9 | 9 | 9 | 9 | 9 | |
| Observation: | APRY Hi | 23,200 | 11,600 | 61,600 | 212,000 | 240,000 | 95,200 | 191,000 | 340,000 | |
| APRY Hi and Lo was | APRY Lo | 232 | 200 | 60 | 10 | 1,720 | 73,920 | 236,000 | 320,000 | |
| unstable after 4 weeks | | | | | | | | | | |
| | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| #622 | Lactics Hi | 2,300 | 4,400 | 9 | 9 | 9 | 9 | 9 | 9 | |
| Na Reduced Mayo | Lactics Lo | 23 | 30 | 9 | 9 | 9 | 9 | 9 | 9 | |
| Point #5 | APRY Hi | 23,200 | 16,200 | 84,000 | 226,000 | 11,760,000 | 88,200 | 208,000 | 640,000 | |
| pH 3.8 | APRY Lo | 232 | 130 | 80 | 720 | 25,200 | 77,280 | 248,000 | 380,000 | |
| Observation: | Uninoc. (PDA) | | 20 | 9 | 9 | 9 | 9 | 9 | 9 | |
| APRY Hi and Lo was | Uninoc. (MRS) | | 9 | 9 | 9 | 9 | 9 | 9 | 9 | |
| unstable after 1 week | | | | | | | | | | |

Table 4 Observations: Sodium reduction up to 50% had no effect on the microbiological behavior of lactic acid bacteria.

TABLE 5
Challenge Data - Sodium Chloride Replacement with Ammonium Chloride

| | | | | | | | | | | |
|---|---|---|---|---|---|---|---|---|---|---|
| #728 | | Calculated | | | | | | | | |
| | | Inoculum | | | | | | | | |
| Test # 6 | Weeks | −1 | 0.0 | 1.0 | 2.0 | 4.0 | 6.0 | 8.0 | 10.0 | 12.0 |
| 50% Na Replacement | Lactics Hi | 7,280 | 8,900 | 9 | 9 | 9 | 9 | 9 | 9 | 9 |
| w/ NH4Cl - | | | | | | | | | | |
| Stable | | | | | | | | | | |
| pH 3.83 | Lactics Lo | 72 | 100 | 9 | 9 | 9 | 9 | 9 | 9 | 9 |
| Aw .931 | Uninoc. (PDA) | | 9 | 9 | 9 | 9 | 9 | 9 | 9 | 9 |
| | Uninoc. (MRS) | | 9 | 9 | 9 | 9 | 9 | 9 | 9 | 9 |
| | APRY Hi | 22,400 | 11,800 | 3,000 | 600 | 9 | 9 | 9 | 9 | 9 |
| | APRY Lo | 224 | 160 | 50 | 10 | 9 | 9 | 9 | 9 | 9 |
| #729 | Lactics Hi | 7,280 | 10,400 | 9 | 9 | 9 | 9 | 9 | 9 | 9 |
| | Lactics Lo | 72 | 160 | 9 | 9 | 9 | 9 | 9 | 9 | 9 |
| Test # 7 | Uninoc. (PDA) | | 9 | 9 | 9 | 9 | 9 | 9 | 9 | 9 |
| 37.5% Na | Uninoc. (MRS) | | 9 | 9 | 9 | 9 | 9 | 9 | 9 | 9 |
| Replacement w/ NH4Cl | | | | | | | | | | |
| pH | APRY Hi | 22,400 | 10,800 | 3,100 | 720 | 10 | 9 | 9 | 9 | 9 |
| Aw .934 | APRY Lo | 224 | 140 | 10 | 10 | 9 | 9 | 9 | 9 | 9 |

NH₄Cl

| | | | | | | | | | | |
|---|---|---|---|---|---|---|---|---|---|---|
| #730 | | Calculated | | | | | | | | |
| | Days | Inoculum | 0 | 7 | 14 | 28 | 42 | 56 | 70 | 84 |
| Test # 8 | | −1 | 0.0 | 1.0 | 2.0 | 4.0 | 6.0 | 8.0 | 10.0 | 12.0 |
| 25% Na Replacement w/ | Lactics Hi | 7,280 | 10,300 | 9 | 9 | 9 | 9 | 9 | 9 | 9 |
| NH4Cl | | | | | | | | | | |
| pH | Lactics Lo | 72 | 120 | 9 | 9 | 9 | 9 | 9 | 9 | 9 |
| Aw .934 | Uninoc. (PDA) | | 10 mold | 9 | 9 | 9 | 9 | 9 | 9 | 9 |
| | Uninoc. (MRS) | | 9 | 9 | 9 | 9 | 9 | 9 | 9 | 9 |
| | APRY Hi | 22,400 | 6,200 | 2,200 | 650 | 20 | 9 | 9 | 9 | 9 |
| | APRY Lo | 224 | 110 | 20 | 10 | 9 | 9 | 9 | 9 | 9 |
| #731 | Lactics Hi | 7,280 | 10,400 | 9 | 9 | 40 | 9 | 9 | 9 | 9 |
| | Lactics Lo | 72 | 120 | 9 | 9 | 9 | 9 | 9 | 9 | 9 |
| Test # 9 | Uninoc. (PDA) | | 9 | 9 | 9 | 9 | 9 | 9 | 9 | 9 |
| 12.5% Na Replacement w/ | Uninoc. (MRS) | | 9 | 9 | 9 | 9 | 9 | 9 | 9 | 9 |
| NH4Cl | | | | | | | | | | |
| pH | APRY Hi | 22,400 | 10,400 | 6,200 | 2,300 | 80 | 9 | 9 | 9 | 9 |
| Aw .934 | APRY Lo | 224 | 200 | 60 | 9 | 9 | 9 | 9 | 9 | 9 |

### Table 5 Observations:

Increasing the equal molar replacement of salt with ammonium chloride resulted in faster APRY die-off

TABLE 6
Replacement with KCl (all stable)

| | | | | Yeast | 1.40E+07 | per ml | Assumed 1,000,000/ml | | | |
|---|---|---|---|---|---|---|---|---|---|---|
| | | | | Pool | | | | | | |
| | | | | Lactic | 4.84E+09 | per ml | Assumed 1,000,000,000/ml | | | |
| | | | | Pool | | | | | | |
| #623 | | Calculated | | | | | | | | |
| | | Inoculum | | | | | | | | |
| Na Reduced Mayo; fully | Weeks | −1 | 0.0 | 1.0 | 2.0 | 4.0 | 6.0 | 8.0 | 10.0 | 12.0 |
| 100% replaced with KCl | | | | | | | | | | |
| Point #6 | Lactics Hi | 2,300 | 4,800 | 9 | 9 | 9 | 9 | 9 | 9 | |
| pH 3.92 | Lactics Lo | 23 | 30 | 9 | 9 | 9 | 9 | 9 | 9 | |
| Observation: | APRY Hi | 23,200 | 18,000 | 1,620 | 80 | 9 | 10 | 9 | 9 | |
| Lactics not impacted | APRY Lo | 232 | 200 | 60 | 9 | 9 | 9 | 9 | 9 | |
| | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| | Lactics Hi | 4,840 | 5,200 | 9 | 9 | 9 | 9 | 9 | 9 | |
| #624 | Lactics Lo | 48 | 60 | 9 | 9 | 9 | 9 | 9 | 9 | |
| Na Reduced Mayo by | APRY Hi | 14,000 | 17,600 | 2,240 | 620 | 40 | 9 | 9 | 9 | |
| 12.5% and with KCl | | | | | | | | | | |
| Point #7 | APRY Lo | 140 | 220 | 40 | 40 | 9 | 9 | 9 | 9 | |
| pH 3.86 | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| | Lactics Hi | 4,840 | 5,600 | 9 | 9 | 9 | 9 | 9 | 9 | |
| #625 | Lactics Lo | 48 | 30 | 9 | 9 | 9 | 9 | 9 | 9 | |
| Na Reduced Mayo | APRY Hi | 14,000 | 18,400 | 2,680 | 370 | 30 | 9 | 9 | 9 | |
| by 25% and with KCl | | | | | | | | | | |
| Point #8 | APRY Lo | 140 | 200 | 40 | 10 | 9 | 9 | 9 | 9 | |
| pH 3.86 | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| #626 | Lactics Hi | 4,840 | 6,000 | 9 | 9 | 9 | 9 | 9 | 9 | |
| Na Reduced Mayo by | Lactics Lo | 48 | 40 | 9 | 9 | 9 | 9 | 9 | 9 | |
| 37.5% and with KCl | | | | | | | | | | |
| Point #9 | APRY Hi | 14,000 | 11,600 | 2,420 | 590 | 50 | 9 | 9 | 9 | |
| | APRY Lo | 140 | 230 | 60 | 9 | 9 | 9 | 9 | 9 | |
| pH 3.88 | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| | Lactics Hi | 4,840 | 6,400 | 9 | 9 | 9 | 9 | 9 | 9 | |
| #627 | Lactics Lo | 48 | 70 | 9 | 9 | 9 | 9 | 9 | 9 | |
| Na Reduced Mayo | APRY Hi | 14,000 | 27,000 | 3,100 | 660 | 80 | 9 | 9 | 9 | |
| by 50% | | | | | | | | | | |
| Point #10 | APRY Lo | 140 | 250 | 50 | 9 | 9 | 9 | 9 | 9 | |
| pH 3.93 | Uninoc. (PDA) | | 9 | 9 | 9 | 9 | 9 | 9 | 9 | |
| | Uninoc. (MRS) | | 9 | 9 | 9 | 9 | 9 | 9 | 9 | |

partial replacement

| | | | | | | | | | | |
|---|---|---|---|---|---|---|---|---|---|---|
| | Weeks | −1 | 0.0 | 1.0 | 2.0 | 4.0 | 6.0 | 8.0 | 10.0 | 12.0 |
| #628 | Lactics Hi | 4,840 | 5,100 | 9 | 9 | 9 | 9 | 9 | 9 | |
| 93.75% NaCl reduced; | Lactics Lo | 48 | 30 | 9 | 9 | 9 | 9 | 9 | 9 | |
| replaced with 87.5% KCl | | | | | | | | | | |
| Point #11 | APRY Hi | 14,000 | 13,200 | 2,360 | 640 | 70 | 9 | 9 | 9 | |
| | APRY Lo | 140 | 170 | 10 | 9 | 9 | 9 | 9 | 9 | |
| pH 3.94 | Uninoc. (PDA) | | 9 | 9 | 9 | 9 | 9 | 9 | 9 | |
| | Uninoc. (MRS) | | 9 | 9 | 9 | 9 | 9 | 9 | 9 | |
| #629 | Lactics Hi | 4,840 | 6,500 | 9 | 9 | 9 | 9 | 9 | 9 | |
| 87.5% NaCl | Lactics Lo | 48 | 60 | 9 | 9 | 9 | 9 | 9 | 9 | |
| reduced and | | | | | | | | | | |
| replaced with 75% | | | | | | | | | | |
| KCl | | | | | | | | | | |
| Point #12 | APRY Hi | 14,000 | 17,400 | 4,500 | 3,020 | 43,200 | 33,000 | 45,000 | 4,600 | |
| pH 3.92 | APRY Lo | 140 | 310 | 40 | 10 | 9 | 9 | 9 | 9 | |
| | Uninoc. (PDA) | | 9 | 9 | 9 | 9 | 9 | 9 | 9 | |
| | Uninoc. (MRS) | | 9 | 9 | 9 | 9 | 9 | 9 | 9 | |

With reference to Table 6, all samples having full or partial sodium chloride replacement with KCl were microbiologically safe and stable, i.e., there was a substantial decrease in the number of viable lactic acid bacteria or APRY yeast after about two (2) weeks with continued inhibition for the duration of the study. Replacement of sodium with potassium had no effect on the microbiological effect of lactic acid bacteria.

Note, that, sample 629, point 12, corresponds to replacing 100% of the salt in the formula with KCl equivalent to 87.5% salt. In this case, APRY yeast levels did not decrease but remained near inoculum levels for the duration of the challenge test. This behavior was similar to that observed in sample 619, point 2, corresponding to a 12.5% reduction in salt levels. Sample 629 remained stable against low APRY insult levels as well as low and high LAB insult levels. Products prepared at plants following good manufacturing practices (GMP's). would typically contain the low insult levels employed in these experiments.

### EXAMPLE 2

### Experimental Design for Potassium Chloride

1. The growth media of the Bidlas et al. reference was used (YM broth and stock pH (6.0). (Growth media—YMB, Sabourda, PDB
2. Three salts (NaCl, KCl, NH₄Cl) were added in a increasing level. With NaCl as the standard at 3%, 6% and 9% on weight basis, equal molar amounts of each salt were studied. The detailed salt amounts are shown in the Table 7 below.
3. The target pH for all compositions was 5.5.
4. The effects on APRY Yeast, instead of pathogens as in Bidlas et al. were studied.
5. Inhibition was measured by CFUs (colony forming units)
6. The results of the challenge study are shown in the Table 8 below. Dramatic increases in APRY yeast levels are observed after more than about two days.

TABLE 7

| | | | Moles in | | Moles in | | Moles in | | Moles in |
|---|---|---|---|---|---|---|---|---|---|
| | | 12 wt. % | 12 wt. % | 9 wt. % | 9 wt. % | 6 wt. % | 6 wt. % | 3 wt. % | 3 wt. % |
| Salt Compound | MW | Solution | NaCl Sol | Solutian | NaCl Sol | Solution | NaCl Sol | Solution | NaCl Sol |
| NaCl (Standard) | 58.442 | 120 g/1 L | 2.053 | 90 g/1 L | 1.54 | 60 g/1 L | 1.027 | 30 g/1 L | 0.5133 |
| KCl | 74.551 | 153.053203 | 2.053 | 114.80854 | 1.54 | 76.563877 | 1.027 | 38.2670283 | 0.5133 |
| (NH4)2PO4 | 130.9824 | 134.4534336 | 2.053 | 201.712896 | 1.54 | 134.5189248 | 1.027 | 67.23326592 | 0.5133 |
| NH4Cl | 53.4913 | 109.8176389 | 2.053 | 82.376602 | 1.54 | 54.9355651 | 1.027 | 27.45708429 | 0.5133 |

TABLE 8

| | −1 | | | | | | | | | | | |
|---|---|---|---|---|---|---|---|---|---|---|---|---|
| Day | (Inoculum) | 0 | ½ | 1 | 1½ | 2 | 5 | 6 | 8 | 11 | 13 | 14 |
| A. | | | | | | | | | | | | |
| 2.05 N | | | | | | | | | | | | |
| NaCl | 2,170 | 9,800 | 5,100 | 2,700 | 7,000 | 4,500 | 1,730 | 2,110 | 1,600 | 700 | 700 | 800 |
| Pool | | | | | | | | | | | | |
| KCl | 2,170 | 7,300 | 7,900 | 3,300 | 8,000 | 68,000 | | | | | | |
| Pool | | | | | | | | | | | | |
| NH4Cl | 2,170 | 8,900 | 5,800 | 3,100 | 10,000 | 36,100 | 700 | 700 | 1,600 | 400 | 600 | 800 |
| Pool | | | | | | | | | | | | |
| DAP | 2,170 | 10,000 | 9,600 | 11,500 | 6,000 | 7,100 | 980 | 5,000 | 2,500 | 4,000 | 1,600 | 3,000 |
| Pool | | | | | | | | | | | | |
| B. | | | | | | | | | | | | |
| 1.54 N | | | | | | | | | | | | |
| NaCl | 2,170 | 13,200 | 3,800 | 2,300 | 8,000 | 3,900 | 2,740 | 1,840 | 3,600 | 3,300 | 2,900 | 3,500 |
| Pool | | | | | | | | | | | | |
| KCl | 2,170 | 13,800 | 7,900 | 11,600 | 85,000 | | | | | | | |
| Pool | | | | | | | | | | | | |
| NH4Cl | 2,170 | 10,900 | 7,200 | 3,100 | 7,000 | 39,500 | 2,200 | 3,000 | 2,900 | 4,600 | 40,000 | 84,000 |
| Pool | | | | | | | | | | | | |
| DAP | 2,170 | 6,000 | 13,000 | 10,300 | 2,000 | 6,700 | 120,900 | 117,600 | 820,000 | 570,000 | 141,000 | 280,000 |
| Pool | | | | | | | | | | | | |
| C. | | | | | | | | | | | | |
| 1.03 N | | | | | | | | | | | | |
| NaCl | 2,170 | 10,000 | 6,900 | 3,200 | 7,000 | 29,000 | | | | | | |
| Pool | | | | | | | | | | | | |
| KCl | 2,170 | 12,000 | 12,300 | 78,000 | 772,000 | | | | | | | |
| Pool | | | | | | | | | | | | |
| NH4Cl | 2,170 | 8,100 | 6,000 | 32,000 | 14,000 | 53,000 | | | | | | |
| Pool | | | | | | | | | | | | |
| DAP | 2,170 | 21,000 | 7,100 | 10,200 | 24,000 | 250,000 | | | | | | |
| Pool | | | | | | | | | | | | |
| D. | | | | | | | | | | | | |
| 0.51 N | | | | | | | | | | | | |
| NaCl | 2,170 | 13,100 | 4,300 | 440,000 | | | | | | | | |
| Pool | | | | | | | | | | | | |
| KCl | 2,170 | 3,800 | 14,200 | 280,000 | | | | | | | | |
| Pool | | | | | | | | | | | | |
| NH4Cl | 2,170 | 10,200 | 11,700 | 260,000 | 672,000 | | | | | | | |
| Pool | | | | | | | | | | | | |
| DAP | 2,170 | 17,600 | 8,100 | 324,000 | 630,000 | | | | | | | |
| Pool | | | | | | | | | | | | |

Table 8A and B show that while the Bidlas, et al. reference discussed above demonstrated that one for one replacement with KCl would inhibit pathogens, KCl does not inhibit the growth of APRY yeast in the broth system.

Table 8 C. and D.—APRY yeast outgrowth was observed at the lowest concentration levels studied.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A method for preserving a dressing composition comprising the steps of:
(a) providing a sodium salt reduced dressing composition which would become microbiologically unstable within about 4 weeks to about 6 weeks at ambient temperature due to said sodium reduction; and
(b) adding KCl and/or NH₄Cl to said sodium reduced dressing composition;
thereby rendering said dressing composition microbiologically safe and stable.

2. The method of claim 2, wherein the dressing composition displays no outgrowth of Lactobacilli bacteria, acid and preservative resistant yeast and mold for at least about six (6) months before opening and when kept at a temperature of 25° C. and at a pH of less than 4.2; or
for at least about six (6) weeks before opening when kept at a pH of less than 6 at a temperature of 5° C.;
and prevents the outgrowth of pathogens, and achieves at least a 2 log decline of pathogens within a fourteen (14) day period when kept at a pH from 3.0 to less than 5.0.

3. The method of claim 1 wherein the food composition is a mayonnaise.

4. The method of claim 1 wherein said dressing composition comprises acetic acid or citric acid, and is substantially free of other preservative acids.

5. The method for preserving a dressing composition according to claim 1 wherein said food composition is acidified to a pH of less than about 4.5.

6. The method for preserving a dressing composition according to claim 1, wherein said food dressing composition displays no outgrowth of acid preservative resistant yeast for at least about six (6) months before opening and when kept at a temperature of 25° C. and at a pH of less than 4.2.

7. The method for preserving a dressing composition according to claim 1, wherein said food dressing composition is an oil-in-water emulsion.

8. The method for preserving a dressing composition according to claim 1, wherein said added salt replacer is NH4Cl.

9. The method for preserving a dressing composition according to claim 1, wherein said added salt replacer is KCl.

10. The method for preserving a dressing composition according to claim 1, wherein said dressing composition is a mayonnaise or mayonnaise type dressing or sauce.

11. The method for preserving a dressing composition according to claim 1, wherein said salt replacement is done on a mole-for-mole basis.
